(19) United States
(12) Patent Application Publication
(10) Pub. No.: US 2013/0172511 A1
(43) Pub. Date: Jul. 4, 2013

(54) BLOCK COPOLYMERS ON THE BASIS OF (METH)ACRYLATE

(71) Applicants: Henkel AG & Co. KGaA, Duesseldorf (DE); Evonik Rohm GmbH, Hanau (DE)

(72) Inventors: Thomas Moeller, Duesseldorf (DE); Volker Erb, Duesseldorf (DE); Uwe Franken, Dormagen (DE); Lars Zander, Neuotting (DE); Hans-Georg Kinzelmann, Pulheim (DE); Holger Kautz, Haltem am See (DE); Sven Balk, Frankfurt (DE); Dirk Kuppert, Aschaffenburg (DE); Stephan Fengler, Frankfurt (DE); Dorothea Staschik, Nidderau (DE); Rebecca Pieroth, Ronneburg (DE)

(73) Assignees: Evonik Rohm GmbH, Hanau (DE); Henkel AG & Co. KGaA, Duesseldorf (DE)

(21) Appl. No.: 13/768,271

(22) Filed: Feb. 15, 2013

Related U.S. Application Data
(63) Continuation of application No. 13/009,186, filed on Jan. 19, 2011, now abandoned.
Application No. 13/009,186 is a continuation of application No. PCT/EP2009/055608, filed on May 8, 2009.

(30) Foreign Application Priority Data
Jul. 21, 2008 (DE) 102008034106.1

(51) Int. Cl. C08G 65/34; C08G 77/42

(52) U.S. Cl. CPC C08G 65/34; C08G 77/42
USPC 528/26; 528/271

(57) ABSTRACT

The invention relates to block copolymers produced by means of controlled polymerization and that have at least one block A or B comprising (meth)acrylate monomers and copolymerizable monomers, and a block P on the basis of functionalized polymers.

### CROSS-REFERENCE TO RELATED APPLICATIONS

This application is a continuation of U.S. patent application Ser. No. 13/009,186 filed Jan. 19, 2011 which is a continuation of International Patent Application No. PCT/EP2009/055608 filed May 8, 2009, which claims priority to German Patent Application No. 10 2008 034 106.1 filed Jul. 21, 2008, the contents of both of which are incorporated herein by reference.

### BACKGROUND OF THE INVENTION

The invention relates to block copolymers that are produced by means of controlled polymerization and have at least one block A or B comprising (meth)acrylate monomers and copolymerizable monomers, and a block P on the basis of functionalized polymers.

WO 2004/056898 describes branched polymers in which the various polymer arms consist of two regions, core and shell, the polymer being an acrylate copolymer. This is produced by radical polymerization and can have a polydispersity of 3 to 10. Low-molecular-weight polyfunctional (meth)acrylates, for example trimethylolpropane triacrylate or pentaerythritol tetraacrylate, which can be extended by radical polymerization, serve as precursors for the polymer.

EP-A 1308493 is also known. Pressure-sensitive adhesives based on block copolymers are described therein. These block copolymers should have the structure P(A)-P(B)-P(A), inter alia also P(B)-P(A)ₙX. The constituent X is described as a polyfunctional branching unit with various polymer arms. Low-molecular-weight vinyl thioesters or analogous ureas or thioureas, for example, are described as examples for producing such systems.

EP-B-1179566 is likewise known. This describes an elastomer composition containing as one constituent a block copolymer consisting of a silicone polymer block and a (meth)acrylate block. Further polymer constituents and a particular production method are not described.

No polymers are known from the prior art which have a central polymer building block containing no (meth)acrylate building blocks but consisting of other polymers. Only the known starter molecules for the various polymerization methods are used. Alternatively, copolymers are known which have a high content of silicone polymers.

It is demonstrated in the cited prior art that acrylate block copolymers can be produced by means of various reaction mechanisms. Such polymers can also be mixed with further different polymers. However, the fact that the compatibility of the polymers with one another when mixed together is frequently not guaranteed is problematic. In particular, compatibility with silicone polymers is frequently problematic. Furthermore, through the use of acrylate block copolymers as the substantial constituent the properties of the compositions produced from this polymer, such as adhesives or sealants, are limited to those of the base polymers. In particular the elasticity, cohesion and adhesion of the materials are frequently not adequate.

### SUMMARY OF THE INVENTION

An object of the present invention is to provide block copolymers based on (meth)acrylate copolymers which through their structure and the polymer blocks used therein allow a combination of the properties of various polymers. The covalent bonding of the polymer constituents should furthermore ensure compatibility and prevent subsequent separation of the various polymers. Moreover, domains defined at a molecular level can be selectively incorporated into the polymer such that particular properties of the compositions produced from this block copolymer can be obtained.

The object is achieved by block copolymers consisting of a block P and at least one block A or block B, P being a polymer building block based on OH, SH, RNH-substituted polyethers, polyesters, polyurethanes, polyamides or polyolefins and having a molecular weight of between 350 and 30,000 g/mol, A being a block based on (meth)acrylate monomers and/or copolymerizable monomers with a Tg>10° C., B being a block based on (meth)acrylate monomers and copolymerizable monomers with a Tg<10° C., and A and P being connected to one another by covalent bonding of P with at least one initiator building block for controlled polymerization. This should subsequently be reacted to blocks A and/or B by means of a controlled polymerization with the meth(acrylate) monomers.

### DETAILED DESCRIPTION OF THE INVENTION

Various base polymers are suitable as the polymer block P in the block copolymers according to the invention. These polymers are known in principle; they are polymers based on polyethers, polyesters, polyurethanes, polyamides or polyolefins These polymers should have one, in particular two, functional groups, which should be nucleophilic groups such as OH, SH or RNH groups. The polymers can be reacted with an initiator via these reactive groups. These can be commercial polymers, which can be selected by the person skilled in the art according to his knowledge of the basic properties. These polymers which can be used as block P in the block copolymers should include the necessary functional groups by virtue of their production; it is also possible for these functional groups to be introduced into the base polymers subsequently by means of polymer-analogous reactions.

Such polymers should have at least one functional group which is capable of a further reaction. Nucleophilic groups are suitable in particular. Electrophilic groups such as anhydride, epoxide or isocyanate groups can also be converted to nucleophilic groups. Examples of such functional groups are OH, NH, SH, COOH, anhydride, epoxide or NCO groups.

One class of suitable polymers as polymer building block P is polyurethane prepolymers. These can be produced by reacting diols and/or triols with diisocyanate or triisocyanate compounds. The proportions are mostly chosen here such that terminally OH-functionalized prepolymers are obtained. The prepolymers should in particular be linear, i.e. be produced predominantly from diols and diisocyanates. An additional use of small proportions of trifunctional polyols or isocyanates is possible. The polyols and polyisocyanates which can be used in the synthesis of the prepolymers are known to the person skilled in the art.

Isocyanates which are suitable for PU prepolymer synthesis are the monomeric aliphatic or aromatic di- or triisocyanates known for use as adhesives. Known oligomers such as biurets, carbodiimides or cyanurates of these isocyanates can also be used. The known polyols having a molecular weight of up to 30,000 g/mol, in particular from 100 to 10,000 g/mol, can be selected as difunctional or trifunctional polyols. They should be selected for example on the basis of polyethers, polyesters, polyolefins, polyacrylates or polyamides, wherein these polymers should have two or three OH groups. Diols having terminal OH groups are preferred. The amount of isocyanate groups is chosen such that OH-functional PU polyols are obtained, or NCO groups can subsequently be converted to OH groups.

In the context of the present invention, polyesters are also polymers that are suitable as P. These can be the known polyesters which can be produced by polycondensation of acid and alcohol components, in particular by polycondensation of a polycarboxylic acid or a mixture of two or more polycarboxylic acids and a polyol or a mixture of two or more polyols, in particular low-molecular-weight polyols, for example with a molecular weight below 400 g/mol. These polyesters can be functionalized in the terminal position with COOH or OH groups; other functional groups are also optionally possible. These are then converted to the aforementioned nucleophilic groups, however.

Examples having an aliphatic, cycloaliphatic, aromatic or heterocyclic parent substance are suitable as the polycarboxylic acid. In place of the free carboxylic acids their acid anhydrides or esters with C₁₋₅ monoalcohols can optionally be used for polycondensation. A large number of polyols can be used as diols for reaction with the polycarboxylic acids. Aliphatic polyols having 2 to 4 primary or secondary OH groups per molecule and 2 to 20 C atoms are suitable, for example. Portions of higher-functional alcohols can likewise be used. Methods for producing such polyester polyols are known to the person skilled in the art and these products are available commercially.

Likewise suitable as the polyol are polyacetals having OH groups in the terminal position. Polycarbonate diols or polycaprolactone diols can also be selected as further polyester polyols.

Polyether polyols can furthermore be used as the polymer building block P. Polyether polyols are preferably obtained by reacting low-molecular-weight polyols with alkylene oxides. The alkylene oxides preferably have two to four C atoms. The reaction products of ethylene glycol, propylene glycol or the isomeric butane diols with ethylene oxide, propylene oxide or butylene oxide are suitable, for example. Reaction products of polyfunctional alcohols such as glycerol, trimethylolethane or trimethylolpropane, pentaerythritol or sugar alcohols with the cited alkylene oxides to give polyether polyols are also suitable. They can be random polyethers or block copolyethers. Polyether polyols obtainable from the cited reactions and having a molecular weight of about 300 to about 30,000 g/mol, preferably about 400 to about 20,000 g/mol, are particularly suitable.

A further suitable class of polyols is OH-functionalized polyolefins Polyolefins are known to the person skilled in the art and can be produced in many molar masses. Such polyolefins based on ethylene, propylene or higher-chain α-olefins as homo- or copolymers can either be produced by copolymerization of portions of monomers containing functional groups or be functionalized by graft reactions. A further possibility consists in subsequently providing these base polymers with OH groups, by oxidation for example.

The monomers which can be used in addition to ethylene and/or propylene are the known olefinically unsaturated monomers which can be copolymerized with ethylene/propylene. In particular they are linear or branched C₄ to C₂₀ α-olefins, such as butene, hexene, methylpentene, octene; cyclically unsaturated compounds, such as norbonene or norbonadiene; symmetrically or asymmetrically substituted ethylene derivatives, with C₁ to C₁₂ alkyl residues being suitable as substituents; and optionally unsaturated carboxylic acids or carboxylic anhydrides. A particularly preferred embodiment uses catalysts based on metallocene to produce the modified polyolefins These (co)polymers have the characterizing feature that they have a narrow molecular weight distribution and the comonomers are particularly preferably distributed evenly along the molecule chain.

A further class of polyols includes a polyamide chain. Polyamides are reaction products of diamines with di- or polycarboxylic acids. By means of selective synthesis it is possible to introduce OH groups into polyamides in the terminal position. Dimerized fatty acids, aliphatic linear dicarboxylic acids or aromatic dicarboxylic acids, for example, can be used as carboxylic acids. Small portions of tricarboxylic acids can also be incorporated by polymerization. Aliphatic diamines, cycloaliphatic diamines and/or polyether diamines are suitable as amines. Mixtures of various diamines are generally used. Such polyamides are known to the person skilled in the art. A functionalization with secondary amino groups, for example, is likewise known.

The polymeric blocks P can be in liquid or solid form, but for further processing it is necessary to be able to produce a solution or an emulsion of the polymer building block P.

The polymer building block P must have at least one functional group selected from OH, SH, RNH. It can also contain 2 to 10 functional groups, preferably 1 to 5, in particular 2 or 3 generally identical functional groups should be contained in the polymer P. In a particular embodiment these functional groups are in the terminal position. The molecular weight of the polymer P should be between 300 and 30,000 g/mol, in particular between 400 and 20,000 g/mol (number-average molecular weight M_{N}, as can be determined by GPC).

The aforementioned polymer building blocks P must contain functional nucleophilic groups, in particular OH groups, SH groups or NHR groups. These groups are then reacted with initiator building blocks for a controlled polymerization. These are compounds having a group Z which can react with the cited nucleophilic groups, together with additionally a group of formula I, II, III or IV,

—CR³₂₋ₘXₘ—COOR², (I)

—C(O)CR³₃₋ₘXₘ, (II)

—(O)CCR³₃₋ₘXₘ, (III)

—Ph—CR³₃₋ₘXₘ (IV)
in which X=Cl, Br, J;
Ph=phenylene, phenyl;
R²=C₁ to C₁₀ alkyl, aliphatic, cycloaliphatic or aromatic;
R³=H or CH₃;
m=1 or 2.

Bromine compounds are preferred.

Alkyl esters with C₁ to C₄ alcohols, isocyanates, carboxylic acids, carboxylic anhydrides, carboxylic halides or epoxide groups can be used for example as the further reactive group Z which can react with the nucleophilic group of P.

The reaction optionally takes place with catalysts, such that the functional group of formula I to IV is retained whilst on the other hand group Z is reacted with the OH, SH or NHR groups. A covalent bonding of the initiator building block to the polymer building block P is obtained in this way.

Examples of such initiator building blocks which are reacted with the nucleophilic groups are R⁴—(CH₂)ₙ—CHX—COOR², R⁴—(CH₂)ₙ—C(CH₃)X—COOR², R⁴—(CH₂)ₙ—CX₂—COOR², R⁴—(CH₂)ₙ—OOC—CH₂X, R⁴—(CH₂)ₙ—OOCCHX—CH₃, R⁴—(CH₂)ₙ—OOCCX—(CH₃)₂, R⁴—(CH₂)ₙ—OOCCHX₂, R⁴—(CH₂)ₙ—OOCCX₂—CH₃, R⁴—(CH₂)ₙ(O)CC(O)CH₂X, R⁴—(CH₂)ₙ(O)CC(O)CHX₂, R⁴—(CH₂)ₙ(O)CC(O)CX₂CH₃, Y(O)C—CH₂X, Y(O)CCHX—CH₃, Y(O)CCX—(CH₃)₂, Y(O)CCHX—C₂H₅, Y(O)CCX(C₂H₅)₂, R⁴—(CH₂)ₙ—CHX-Ph, R⁴—(CH₂)ₙ—CX₂-Ph, o,- m- or p-R⁴-Ph-CH₂X, o,- m- or p-R⁴-Ph-CHXCH₃, o,- m- or p-R⁴-Ph-CX—(CH₃)₂, o,- m- or p-R⁴-Ph-CX₂CH₃, o,- or p-R⁴-Ph-CHX₂, o,- m- or p-R⁴-Ph-OOCCH₂X, o,- m- or p-R⁴-Ph-OOCCHXCH₃, o,- m- or p-R⁴-Ph-OOCCX—(CH₃)₂(CH3)2, R⁴-Ph—OOCX₂CH₃, o,- m- or p-R⁴-Ph—OOCCHX₂ or o,- or p-R⁴-Ph-SO₂X , where R⁴ denotes a C₁ to C₆ alkyl residue substituted with a group Z as isocyanate or epoxide group and Y denotes OH, X, methoxy or ethoxy. Haloacid derivatives, for example 2-haloacids, such as 2-bromopropionic acid, 2-bromoisobutyric acid, 2-chloropropionic acid, 2-chloroisobutyric acid; 2-haloacid esters, such as 2-bromopropionic acid methyl ester, 2-bromoisobutyric acid ethyl ester, 2-chloropropionic acid methyl ester, 2-chloroisobutyric acid ethyl ester; 2-haloacid halides, such as 2-bromopropionic acid bromide, 2-bromoisobutyric acid bromide, 2-chloropropionic acid chloride or 2-chloroisobutyric acid chloride, are preferably used.

The amount of initiator building block is chosen such that there is at least one initiator molecule reacted at the polymers P. It is preferable for all OH, NH or SH groups to be reacted with an initiator molecule.

The reaction of the polymers with the initiators conventionally takes place in organic solvents. The conventional organic solvents can be used here. It is preferable for the boiling point of the solvents to be below 140° C. In a subsequent process step the solvent can then optionally be removed by distillation.

According to the invention the correspondingly functionalized polymer building block P is then reacted further. Here the initiator group is reacted with the known catalysts and the corresponding unsaturated monomers selected from (meth)acrylate monomers, vinyl-substituted aromatic monomers or other unsaturated, copolymerizable monomers. There are in principle a plurality of known polymerization methods which starting from the functionalized polymer building block P achieve a controlled polymerization of P.

If one initiator group is present at block P, then polymers with the structure A-P or B-P are obtained. If two initiator groups are present per polymer P, then polymers with the structure A-P-A or B-P-B are obtained. If more than two initiator groups are included at polymer P, then branched or star-shaped structures are formed.

The production of block copolymers based on (meth)acrylates by means of group transfer polymerization (GTP) is described. This method can be used to produce the polymer blocks A and B according to the invention.

Living or controlled polymerization methods, such as for example anionic or group transfer polymerization, are suitable as a further method. The polymer blocks A and B can be constructed using these polymerization methods. A further method is RAFT polymerization, or polymerization to give blocks A and B can be performed by means of nitroxides. A preferred production method according to the invention is ATRP polymerization, however.

Catalysts for ATRP are listed in Chem. Rev. 2001, 101, 2921. Copper complexes are described predominantly, but iron, rhodium, platinum, ruthenium or nickel compounds inter alia can also be used. All transition metal compounds which can form a redox cycle with the initiator or with the polymer chain containing a transferable atom group can generally be used.

Monomers based on (meth)acrylates can be selected for blocks A and B. The notation (meth)acrylate denotes esters of (meth)acrylic acid and means both methacrylate esters, acrylate esters or mixtures of the two. Furthermore, copolymerizable unsaturated monomers, in particular also vinyl aromatic monomers, can be polymerized with these (meth)acrylates. The glass transition temperature can be influenced by the selection of the monomers. Monomers having a low glass transition temperature as homopolymers, in particular <10° C., are regarded as soft monomers. Monomers having a glass transition temperature >10° C. as homopolymers are regarded as hard monomers.

Homopolymer blocks can be produced, but it is preferable if blocks A and B are copolymers consisting of at least two monomers, in a random distribution for example. It is likewise possible to produce polymer blocks A and B which exhibit a gradient in the concentration of the monomers. It is furthermore also possible to incorporate (meth)acrylate monomers bearing further functional groups, such as for example OH groups, carboxyl groups, NH groups, epoxide groups or others, into blocks A or B by polymerization. It is important here to ensure that these functional groups do not interact with the polymerization reaction, i.e. (meth)acrylic double bonds, isocyanate groups or halogen groups as additional reactive groups of the monomers should be avoided.

In the context of this invention blocks A have a high T_{g} which is greater than 10° C., in other words they are hard blocks. Blocks B have a T_{g} which is less than 10° C., in other words they are soft blocks (glass transition temperature T_{g}, measured by DSC). The monomers which can be used for the individual blocks are known to the person skilled in the art. Glass transition temperatures of homopolymers are described in the literature.

Monomers which can be polymerized both in block A and in block B can be selected from the group of (meth)acrylates, such as for example alkyl (meth)acrylates of straight-chain, branched or cycloaliphatic alcohols having 1 to 40 C atoms, such as for example methyl (meth)acrylate, ethyl (meth)acrylate, n-butyl (meth)acrylate, i-butyl (meth)acrylate, t-butyl (meth)acrylate, pentyl (meth)acrylate, 2-ethylhexyl (meth)acrylate, stearyl (meth)acrylate, lauryl (meth)acrylate, cyclohexyl (meth)acrylate, isobornyl (meth)acrylate; aryl (meth)acrylates such as for example benzyl (meth)acrylate or phenyl (meth)acrylate which can each have unsubstituted or mono- to tetrasubstituted aryl residues; other aromatically substituted (meth)acrylates such as for example naphthyl (meth)acrylate; mono(meth)acrylates of ethers, polyethylene glycols, polypropylene glycols or mixtures thereof having 5-80 C atoms, such as for example tetrahydrofurfuryl methacrylate, methoxy(m)ethoxyethyl methacrylate, 1-butoxypropyl methacrylate, cyclohexyloxymethyl methacrylate, benzyloxymethyl methacrylate, furfuryl methacrylate, 2-butoxyethyl methacrylate, 2-ethoxyethyl methacrylate, allyloxymethyl methacrylate, 1-ethoxybutyl methacrylate, 1-ethoxyethyl methacrylate, ethoxymethyl methacrylate, poly(ethylene glycol)methyl ether (meth)acrylate and poly(propylene glycol)methyl ether (meth)acrylate.

Hydroxy-functionalized (meth)acrylates can also be polymerized in block A or B, for example hydroxyalkyl (meth)acrylates of straight-chain, branched or cycloaliphatic diols having 2-36 C atoms, such as for example 3-hydroxypropyl (meth)acrylate, 3,4-dihydroxybutyl mono(meth)acrylate, 2-hydroxyethyl (meth)acrylate, 4-hydroxybutyl (meth)acrylate, 2-hydroxypropyl (meth)acrylate, 2,5-dimethyl-1,6-hexanediol mono(meth)acrylate, particularly preferably 2-hydroxyethyl methacrylate.

In addition to the (meth)acrylates described above, the compositions to be polymerized can also contain further unsaturated monomers which are copolymerizable with the aforementioned (meth)acrylates and in particular by means of ATRP. These include inter alia 1-alkenes, such as 1-hexene, 1-heptene, branched alkenes such as for example vinyl cyclohexane, 3,3-dimethyl-1-propene, 3-methyl-1-diisobutylene, 4-methyl-1-pentene, acrylonitrile, vinyl esters such as for example vinyl acetate, styrene, substituted styrenes with an alkyl substituent at the vinyl group, such as for example α-methyl styrene and α-ethyl styrene, substituted styrenes having one or more alkyl substituents at the ring, such as vinyl toluene and p-methylstyrene, halogenated styrenes such as for example monochlorostyrenes, dichlorostyrenes, tribromostyrenes and tetrabromostyrenes; heterocyclic compounds such as 2-vinylpyridine, 3-vinyl pyridine, 2-methyl-5-vinyl pyridine, 3-ethyl-4-vinyl pyridine, 2,3-dimethyl-5-vinyl pyridine, vinyl pyrimidine, 9-vinyl carbazole, 3-vinyl carbazole, 4-vinyl carbazole, 2-methyl-1-vinyl imidazole, vinyl oxolane, vinyl furan, vinyl thiophene, vinyl thiolane, vinyl thiazoles, vinyl oxazoles and isoprenyl ethers; maleic acid derivatives, such as for example maleic anhydride, maleinimide, methyl maleinimide and dienes such as for example divinyl benzene, as well as the corresponding hydroxy-functionalized and/or amino-functionalized and/or mercapto-functionalized compounds. These copolymers can furthermore also be produced in such a way that they have a hydroxy and/or amino and/or mercapto functionality in one substituent. Such monomers are for example vinyl piperidine, 1-vinyl imidazole, N-vinyl pyrrolidone, 2-vinyl pyrrolidone, N-vinyl pyrrolidine, 3-vinyl pyrrolidine, N-vinyl caprolactam, N-vinyl butyrolactam, hydrogenated vinyl thiazoles and hydrogenated vinyl oxazoles. Vinyl esters, vinyl ethers, fumarates, maleates, styrenes or acrylonitriles are particularly preferably copolymerized with the A blocks and/or B blocks.

Monomers, at 0 wt. % to 50 wt. %, in particular up to 25 wt. %, that can be polymerized by ATRP and that do not belong to the group of (meth)acrylates can be added to both the copolymers of block A and the copolymers of blocks B.

The method can be performed in any halogen-free solvents. Toluene, xylene, H₂O; acetates, preferably butyl acetate, tert-butyl acetate, ethyl acetate, propyl acetate; ketones, preferably ethyl methyl ketone, acetone; ethers; alcohols, preferably those having 1 to 10 C atoms; aliphates, preferably pentane, hexane, iso-octane, are preferred.

Polymerization can be performed under normal pressure, reduced pressure or excess pressure. The polymerization temperature too is uncritical. However, it is generally in the range from −20° C. to 200° C., preferably from 0° C. to 130° C. and particularly preferably from 50° C. to 120° C.

The block copolymer according to the invention must contain a block P and at least one block A or B. Block copolymers according to the invention can also have the structure A-P-A or B-P-B. With more than two initiator building blocks per block P, star-shaped block copolymers can be obtained. It is also possible to produce sequential polymer blocks by means of the production processes suitable according to the invention. Here a block of structure B can follow a block of structure A or vice versa. It is likewise possible to polymerize a plurality of different blocks sequentially one after another, for example (AB)-P, where n can be 1 to 10,preferably 1 to 3. Structures ABA or BAB, which are reacted at polymer building block P, can also be included. The block copolymers according to the invention are conventionally symmetrically structured, i.e. the (meth)acrylate blocks reacted at polymer block P have the same structure.

An embodiment of the block copolymers according to the invention contains blocks A and B which have no further functional groups. These polymers are therefore not reactive in later use. Another embodiment of the block copolymers according to the invention has one or more functional groups in either block A or block B. OH groups, epoxide groups, amino groups, thio groups, silyl groups, allyl groups, acid groups or similar functional groups, for example, can be included as functional groups. The number of functional groups per block should be 1 to 10, in particular up to 3 functional groups per block. These can be randomly distributed along the block or concentrated at one end of the block. In a particular embodiment block A or B contains 1 or 2 monomers in the terminal position having a functional group of the same type.

The glass transition temperature of the (meth)acrylate blocks can be adjusted within broad limits. According to the invention block A should have a T_{g} greater than 10° C., in particular >30° C. Furthermore block B should have a T_{g} less than 10° C., in particular <0° C.

In a particular embodiment it is possible to obtain block copolymers having a block P and symmetrically thereto a block A or a block B, a reactive functional group being included at the ends of the (meth)acrylate chains.

The polymer according to the invention preferably has a number-average molecular weight between 5000 g/mol and 120,000 g/mol, particularly preferably below 80,000 g/mol and most particularly preferably between 7500 g/mol and 50,000 g/mol. It was found that the molecular weight distribution is below 1.9, preferably below 1.7, particularly preferably below 1.5. It is convenient if the proportion of all (meth)acrylate blocks A and B is between 10 and 80 wt. % of the block copolymers according to the invention, in particular more than 20 wt. %, preferably between 30 and 60 wt. %.

Following ATRP the transition metal compound can be precipitated by adding a suitable sulfur compound. The transition metal ligand complex is quenched and the “bare” metal is precipitated out. The polymer solution can then easily be purified by means of a simple filtration. The said sulfur compounds are preferably compounds having an SH group. It is most particularly preferably a regulator known from free-radical polymerization, such as mercaptoethanol, ethylhexyl mercaptan, n-dodecyl mercaptan or thioglycolic acid. The copper content can be reduced to less than 5 ppm, in particular below 1 ppm.

The block copolymers according to the invention are conventionally produced in organic solution or in aqueous emulsions. After polymerization and processing it is possible optionally to remove the solvent. It can, however, optionally be convenient for subsequent processing for a solution of the polymers to be obtained.

In addition to solution polymerization, ATRP can also be performed as emulsion, miniemulsion, microemulsion, suspension or bulk polymerization.

The polymers according to the invention can be processed further in various ways. They can for example be used as the polymeric main constituent in adhesives; sealants, potting compounds, foams or coating agents; they can also be added as additives, i.e. in small amounts, for example up to 10%, to the aforementioned compositions. They can be non-crosslinking compositions, in which case in particular non-reactive block copolymers according to the invention are also used, but they can also be reactive crosslinking compositions. In this case it is possible to use block copolymers containing reactive groups or non-reactive block copolymers. These can be selected for example such that they react with the reactive groups of the compositions. It is further possible to use the reactive block copolymers according to the invention as main binders in crosslinkable compositions.

It is possible selectively to influence the properties of the compositions through the combination of poly(meth)acrylate blocks A and B and blocks P which are different from the poly(meth)acrylates. If block copolymers having high proportions of P are used, these polymer properties are more clearly pronounced. If polymers having a high proportion of (meth)acrylate blocks are used, the acrylate properties are more strongly pronounced.

Problems relating to the compatibility of polymers can be avoided by the use of the polymers according to the invention in crosslinkable or plastic materials. Even poorly compatible polymers can be used if they have an improved compatibility with block P. The polymer P cannot separate out of a corresponding composition because even in the uncrosslinked state it is chemically bonded to the (meth)acrylate blocks.

Broad access to curable plastic or crosslinkable plastic compositions is achieved through the block copolymers according to the invention. Their properties can be selectively influenced according to the choice of the polymer P. Incompatibilities can be avoided. The narrow molecular weight distribution means that the viscosity properties of the polymers and hence the viscosity properties of the compositions can also be influenced, thereby improving processability.

### EXAMPLES

The following examples are intended to illustrate the invention without restricting the invention in any way.

The number-average or weight-average molecular weights M_{N} or M_{W} and the molecular weight distributions M_{W}/M_{N} are determined by gel permeation chromatography (GPC) in tetrahydrofuran in comparison to a PMMA standard.

The glass transition temperatures are measured by differential scanning calorimetry (DSC) as described in DIN EN ISO 11357-1.

The OH value was determined in accordance with DIN 53240.

The softening point is determined in accordance with DIN 52011.

### Polymer Example 1

990 g of polyether diol with an OH value of 47.1 and a propylene oxide content of 90 wt. % and an ethylene oxide content of 10 wt. % were dissolved in 1 liter of toluene and cooled to 0° C. under a nitrogen atmosphere. After the addition of 88.3 g of triethylamine, a solution of 194.4 g of bromoisobutyric acid bromide in 200 ml of toluene was added dropwise whilst stirring in such a way that the internal temperature remained below 10° C. The mixture was then stirred overnight at room temperature. The precipitated salt was filtered off and the solvent was drawn off under vacuum in a rotary evaporator (120° C. oil bath temperature, 2 mbar pressure). The desired product 1 is obtained as a clear liquid.

112 g of product 1, 125 ml of toluene, 5.6 g of copper(I) oxide and 13.7 g of N,N,N′,N″,N″-pentamethyl diethylene triamine (PMDETA) were placed in a reaction flask equipped with a stirrer, thermometer, reflux condenser, nitrogen feed pipe and dropping funnel under an N2 atmosphere. Then 1366 g of BA in 1500 ml of toluene were added and the mixture polymerized at 80° C. for five hours. After the polymerization time of five hours a sample was removed to determine the average molecular weight Mn (Mn=34,500, Mw/Mn=1.6) and 493 g of MMA in 550 ml of toluene were added. The mixture was polymerized up to an anticipated conversion of at least 90% and the reaction was terminated by the addition of 23.9 g of n-dodecyl mercaptan. The solution was processed by filtering over silica gel and then removing volatile constituents by means of distillation. The average molecular weight was then determined by SEC measurements (Mn=41,500, Mw/Mn=1.7).

### Polymer Example 2

The macroinitiator (product 2) was produced in the manner described in polymer example 1 from a polyether diol with an OH value of 77.2.

57.2 g of product 2, 60 ml of toluene, 6.5 g of copper(I) oxide and 14.0 g of N,N,N′,N″,N″-pentamethyl diethylene triamine (PMDETA) were placed in a reaction flask equipped with a stirrer, thermometer, reflux condenser, nitrogen feed pipe and dropping funnel under an N2 atmosphere. Then 1420 g of BA in 1400 ml of toluene were added and the mixture polymerized at 80° C. for five hours. After the polymerization time of five hours a sample was removed to determine the average molecular weight Mn (Mn=13,400, Mw/Mn=1.7) and 500 g of MMA in 490 ml of toluene were added. The mixture was polymerized up to an anticipated conversion of at least 90% and the reaction was terminated by the addition of 26.1 g of n-dodecyl mercaptan. The solution was processed by filtering over silica gel and then removing volatile constituents by means of distillation. The average molecular weight was then determined by SEC measurements (Mn=17,000, Mw/Mn=1.6).

### Pressure-Sensitive Adhesive—Example 1

A PMMA-PBA-polyether-PBA-PMMA polymer according to polymer example 1 (amount 69.5%) with a molar mass of approx. 12,800 g/mol was mixed with a commercial styrene-acrylate resin with an acid value of approx. 112 mg KOH/g, a softening point of approx. 82° C. and a molar mass of approx. 13,400 (amount 30%) and a stabilizer (Irganox 1010 from Ciba) (amount 0.5%) whilst melting.

The formulation had a melt viscosity measured with a Brookfield Thermosel RVT II of approx. 3800 mPa·s/170° C.

The mixture was applied with a coating thickness of 20 μm.

The evaluation resulted in the following values:
Loop tack (FINAT test method no. 9) 8.2 N (adhesive failure),
180° peel strength (FINAT test method no. 1) 11.4 N/25 mm (adhesive failure),
Shear strength (FINAT test method no. 8) 4 hours (cohesive failure).

### Pressure-Sensitive Adhesive—Example 2

A PMMA-PBA-polyether-PBA-PMMA polymer according to polymer example 2 (69.5%) with a molar mass of approx. 17,000 g/mol was mixed with a commercial styrene-acrylate resin with an acid value of approx. 112 mg KOH/g, a softening point of approx. 82° C. and a molar mass of approx. 13,400 (30%) and a stabilizer (Irganox 1010 from Ciba) (0.5%) whilst melting.

The formulation had a melt viscosity measured with a Brookfield Thermosel RVT II of approx. 2700 mPa·s/170° C.

The mixture was applied with a coating thickness of 20 μm.

The evaluation resulted in the following values:
Loop tack (FINAT test method no. 9) 12.3 N (cohesive failure),
180° peel strength (FINAT test method no. 1) 11.7 N/25 mm (adhesive failure),
Shear strength (FINAT test method no. 8) 16 hours (cohesive failure).

### Solvent-Based Adhesive—Example 3

A PMMA-PBA-polyether-PBA-PMMA according to polymer example 1 (79.5%), dissolved in 30% ethyl acetate, a styrene-acrylate resin according to example 1 (30%) and a stabilizer (Irganox 1010 from Ciba) (0.5%) were mixed together.

The mixture was applied with a 50 μm nip and dried for 5 min at 90° C.

The evaluation resulted in the following values:
Loop tack (FINAT test method no. 9) 18.6 N (adhesive failure),
180° peel strength (FINAT test method no. 1) 8.2 N/25 mm (cohesive failure),
Shear strength (FINAT test method no. 8) 5.2 hours (cohesive failure).

### Solvent-Based Adhesive—Example 4

A polymer according to polymer example 2 (99.5%), dissolved in 30% ethyl acetate, and a stabilizer (Irganox 1010 from Ciba) (0.5%) were homogenized.

The mixture was applied with a 50 μm nip and dried for 5 min at 90° C.

The evaluation resulted in the following values:
Loop tack (FINAT test method no. 9) 5.5 N (adhesive failure),
180° peel strength (FINAT test method no. 1) 0.9 N/25 mm (adhesive failure),
Shear strength (FINAT test method no. 8) 3.0 hours (cohesive failure).

### Pressure-Sensitive Adhesive—Example 5

49.5% of polymer example 1 were mixed with 20% of a PMMA-PBA-siloxane-PBA-PMMA with a molar mass of approx. 40,000 g/mol (produced as described in EP-A 1375605) and 30% of a styrene-acrylate resin with an acid value of approx. 112 mg KOH/g and a softening point of approx. 82° C., together with 0.5% of a stabilizer (Irganox 1010 from Ciba).

The formulation had a melt viscosity measured with a Brookfield Thermosel RVT II of approx. 4500 mPa·s/180° C.

The mixture was applied with a coating thickness of 20 μm.

The evaluation resulted in the following values:
Loop tack (FINAT test method no. 9) 0.6 N (adhesive failure),
Shear strength (FINAT test method no. 8) 6.9 hours (cohesive failure)

What is claimed is:

1. A block copolymer comprising a block P, block A and a block B, wherein
P is a polymer block based on OH, SH, RNH-substituted polyethers, polyesters, polyurethanes, polyamides or polyolefins and has a number-average molecular weight of between 300 and 30,000 g/mol,
A is a block based on (meth)acrylate monomers and/or copolymerizable monomers with a Tg>10° C.,
B is a block based on (meth)acrylate monomers and copolymerizable monomers with a Tg<10° C.,
A, B and P being connected to one another by covalent bonding of P with at least one initiator building block which is covalently bonded with blocks A and/or B through a controlled polymerization.

2. The block copolymer according to claim 1, wherein all OH, SH, RNH groups of P are functionalized with an initiator building block and reacted to give an A and/or B block.

3. The block copolymer according to claim 1, wherein block A and/or block B is a multi-block with the structure (AB)n or (BA)n, where n=1 to 10.

4. The block copolymer according to claim 1, wherein block A is a homopolymer or copolymer, taking the form of a gradient or random polymer in the case of a copolymer.

5. The block copolymer according to claim 1, wherein block P has a functionality of 1 to 10.

6. The block copolymer according to claim 1, wherein blocks A or B each have one or more functional groups.

7. The block copolymer according to claim 6, wherein blocks A or B lying at the end of the polymer have one functional group in the terminal position.

8. The block copolymer according to claim 1, wherein block A is largely or exclusively constructed from vinyl-substituted aromatic monomers.

9. The block copolymer according to claim 1, wherein blocks A and B are produced by ATRP polymerization.

10. The block copolymer according to claim 1, wherein the polymer building block P is a polyether diol or polyether triol produced on the basis of ethylene glycol, propylene glycol or tetrahydrofuran, or a polyester diol or triol produced from aliphatic and/or aromatic dicarboxylic acids with low-molecular-weight diols, in particular having a molecular weight of 400 to 20,000 g/mol.

11. A method for producing block copolymers comprising a block P and at least one block A and block B, wherein a polymer building block containing OH, SH, RNH groups is used as block P, in which at least one of the OH, SH, or RNH groups of the polymer building block is reacted with haloacid derivatives and this reaction product is polymerized by ATRP reaction with radically polymerizable monomers selected from (meth)acrylates, styrene and monomers that are copolymerizable therewith.

12. The method according to claim 11, wherein blocks A and/or B have a multi-block structure and the blocks are produced sequentially.

13. The method according to claim 11, wherein after polymerization the ATRP catalyst is precipitated by addition of a mercaptan or a thiol-group-containing compound and separated from the polymer solution by filtration.

14. A block copolymer comprising a block P, a block A and a block B, wherein
P is a polymer block based on OH, SH, RNH-substituted polyethers, polyesters, polyurethanes, polyamides or polyolefins and has a number-average molecular weight of between 300 and 30,000 g/mol,
A is a block based on (meth)acrylate monomers and/or copolymerizable monomers with a Tg>10° C.,
B is a block based on (meth)acrylate monomers and copolymerizable monomers with a Tg<10° C., and
wherein A, B and P are each connected to one another by covalent bonding of P with at least one initiator building block which is covalently bonded with blocks A and/or B through controlled radical polymerization and wherein the block copolymer has a polydispersity of less than 1.9.

15. A method for producing block copolymers having a polydispersity less than 1.9 comprising a block P, a block A and a block B, wherein a polymer building block containing OH, SH, RNH groups is used as block P, wherein at least one of the OH, SH, or RNH groups of the polymer building block is reacted with haloacid derivatives and this reaction product is polymerized by ATRP reaction with radically polymerizable monomers selected from (meth)acrylates, styrene and monomers that are copolymerizable therewith.
